(19) United States
(12) Patent Application Publication
(10) Pub. No.: US 2010/0255401 A1
(43) Pub. Date: Oct. 7, 2010

(54) FUEL CELL STACK HAVING GROOVED END PLATES AND FUEL CELL SYSTEM

(75) Inventors: Jin-Hwa LEE, Suwon-si (KR); Jun-Won Suh, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/753,993

(22) Filed: Apr. 5, 2010

(30) Foreign Application Priority Data
Apr. 7, 2009 (KR) 10-2009-0029942

(51) Int. Cl. H01M 8/24

(52) U.S. Cl. 429/467

(57) ABSTRACT

A fuel cell stack including an electricity generator and end plates disposed at respective ends of the electricity generator, each of the end plates including first and second grooves extending at perpendicular directions and reinforcing members placed on the first and second grooves.

### CROSS-REFERENCE TO RELATED APPLICATION

This application claims the benefit of Korean Patent Application No. 10-2009-0029942, filed Apr. 7, 2009 in the Korean Intellectual Property Office, the disclosure of which is incorporated herein by reference.

### BACKGROUND OF THE INVENTION

1. Field of the Invention

The described technology relates generally to a fuel cell stack and a fuel cell system. More particularly, it relates to a fuel cell stack of which an end plate is improved and a fuel cell system therewith.

2. Description of the Related Art

A fuel cell electrochemically generates power by using a fuel (hydrogen or reformed gas) and an oxidizing agent (oxygen or air), and converts the fuel and the oxidizing agent that are continuously supplied from an external source to electric energy in the form of direct current by using a chemical energy reaction. Pure oxygen or air enriched with oxygen are used as the oxidizing agent of the fuel cell, and a fuel enriched with pure hydrogen or hydrogen generated from a reformed hydrocarbon fuel (LNG, LPG, or CH₃OH) is used as the fuel.

The fuel cell may be classified as a polymer electrolyte membrane fuel cell (PEMFC), a direct oxidation fuel cell, and a direct methanol fuel cell (DMFC). The PEMFC includes a fuel cell main body called a stack, and has a structure in which electrical energy is generated through an electrochemical reaction between a hydrogen gas supplied from a reformer and air supplied from an air pump or a fan. Here, the reformer functions as a fuel processing device that reforms a fuel, generates hydrogen gas from the reformed fuel, and supplies the hydrogen gas to the stack.

Unlike the PEMFC, the direct oxidation fuel cell is directly supplied with an alcohol-based fuel, and generates electrical energy from an electrochemical reaction of hydrogen included in the fuel and air that is supplied separately without using hydrogen gas. The direct methanol fuel cell refers to a cell among the direct oxidation fuel cells that uses methanol as a fuel.

The fuel cell includes a stack formed of a plurality of stacked cells. The cells are pressed by an end plate installed at the most external part thereof and integrally fixed thereto. However, a conventional fuel cell has a problem in that stress is centralized in an area that is adjacent to a fastening member during a process of fixing the end plate with the fastening member and a nut for assembling a stack. The fastening member is installed adjacent to a fuel manifold or an oxidizing agent manifold so that excessive pressure is applied to inlets of a fuel path and an oxidizing agent path. When excessive pressure is applied to the inlets of the paths, the inlets are narrowed so that the fuel and the oxidizing agent cannot easily flow in. As described, when the fuel cannot easily flow in, a deviation between cells is increased and performance of the fuel cell is deteriorated.

In addition, a portion of the end plate, adjacent to the fastening member installed along an edge of the end plate, is deformed so that pressure cannot be properly applied to a center portion of the stack. As described, when the center portion is not pressed, adhesive force between cells is decreased, thereby decreasing generating efficiency.

The above information disclosed in this Background section is only for enhancement of understanding of the background of the described technology and therefore it may contain information that does not form the prior art that is already known in this country to a person of ordinary skill in the art.

### SUMMARY OF THE INVENTION

An aspect of the present invention, provides a fuel cell system and a fuel cell stack that can apply uniform pressure to a stack.

According to another aspect of the present invention, a fuel cell stack includes an electricity generator that generates electricity with reaction of a fuel and an oxidizing agent and an end plate disposed at the outermost part of the electricity generator, and a first groove extended in one direction is formed in the end plate and a first reinforcing member that supports the end plate is inserted in the firs groove.

According to another aspect of the present invention, the fuel cell stack may include a plurality of electricity generators, and each of the electricity generators includes a membrane electrode assembly (MEA) and separators disposed at respective sides of the MEA. According to another aspect of the present invention, two end plates may be installed in the outermost part of the electricity generator, a first reinforcing member may be formed in each of the end plates, and a fastening member that presses the first reinforcing member may be installed in the first reinforcing member.

According to another aspect of the present invention, the fastening member may include a bolt that penetrates the first reinforcing member and a nut installed to the bolt and the fastening member may include a bolt that penetrates the first reinforcing member and a nut installed to the bolt.

According to another aspect of the present invention, the first reinforcing member may support a portion that is adjacent to a center of the end plate and the first groove may be extended from one end of the end plate to the other end thereof.

According to another aspect of the present invention, the first reinforcing member may be made of a material of which strength is greater than the end plate, and the end plate may be made of a material of which corrosion resistance is greater than the first reinforcing member.

According to another aspect of the present invention, a second groove that crosses the first groove may be formed in the end plate and a second reinforcing member that presses the end plate may be formed in the second groove, and the second groove may perpendicularly cross the first groove.

According to another aspect of the present invention, the first or second groove may include a plurality of grooves, and the first reinforcing member may be inserted below the second reinforcing member so that the second reinforcing member supports the first reinforcing member.

According to another aspect of the present invention, the second reinforcing member may be placed below the first reinforcing member so that the first reinforcing member supports the second reinforcing member, and a pressure protrusion may be formed in the second reinforcing member. In addition, a pressure protrusion may be formed in the first reinforcing member or the second reinforcing member in an area where the first and second reinforcing members are in contact with each other.

According to another aspect of the present invention, a fuel cell system includes a fuel cell stack that generates electricity with a reaction between a fuel and an oxidizing agent, a fuel supply source that supplies a fuel to the stack, and an oxidizing agent supply source that supplies an oxidizing agent to the stack. The fuel cell stack includes an electricity generator that includes a membrane electrode assembly (MEA) and separators disposed at respective sides of the MEA and an end plate disposed the outermost part of the electricity generator, and a first groove extended in one direction and formed in the end plate and a first reinforcing member that supports the end plate inserted into the end plate.

According to another aspect of the present invention, a second groove that crosses the first groove may be formed in the end plate and a second reinforcing member that supports the end plate may be inserted into the second groove, and a pressure protrusion may be formed in the first reinforcing member or the second reinforcing member.

According to another aspect of the present invention, two end plates may be installed in the outermost part of the electricity generator, a fastening member that supports the end plates may be formed penetrating the end plates, and the fastening member may penetrate the first reinforcing member of the second reinforcing member.

As described, according to embodiments of the present invention, application of excessive pressure to the fuel path and the oxidizing agent path of the fuel cell stack can be prevented, and stable fastening force can be applied to a center portion of the stack.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a fuel cell system according to an exemplary embodiment of the present invention;

FIG. 2 is an exploded perspective view of a fuel cell stack of FIG. 1;

FIG. 3 is an exploded perspective view of an end plate according to a first exemplary embodiment of the present invention;

FIG. 4 is an exploded perspective view of an end plate according to a second exemplary embodiment of the present invention;.

FIG. 5 is a perspective view of an end plate according to a third exemplary embodiment of the present invention and

FIG. 6 is a cross-sectional view of FIG. 5, taken along the line VI-VI.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

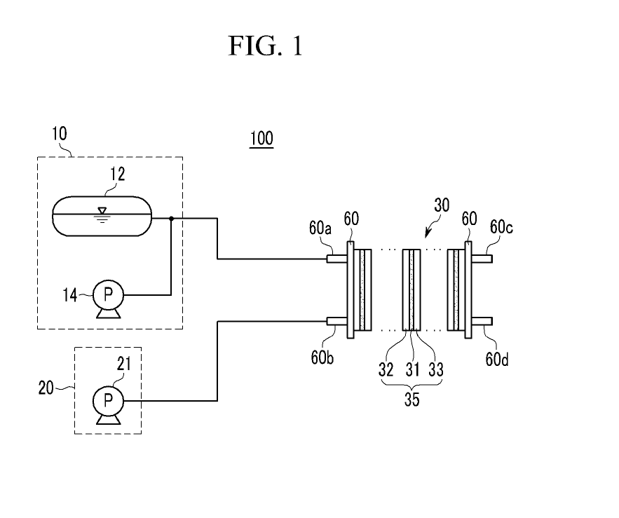

FIG. 1 is a schematic diagram of the entire configuration of a fuel cell system according to an exemplary embodiment of the present invention. Referring to FIG. 1, a fuel cell system 100 may employ a direct methanol fuel cell (DMFC) that generates electrical energy through a direct reaction of methanol and oxygen. However, this aspect of the present invention is not limited thereto, and the fuel cell system according to the present exemplary embodiment may be formed of a direct oxidation fuel cell (DOFC) that reacts liquid containing hydrogen such as ethanol, LPG, LNG, gasoline, butane gas, or a gas fuel with oxygen. In addition, the fuel cell system may be formed of a polymer electrode membrane fuel cell (PEMFC) that uses a fuel by reforming the fuel to a reformed gas enriched with hydrogen.

A fuel used in the fuel cell system 100 generally represents a hydrocarbon-based fuel in a liquid or gas state, such as methanol, ethanol, natural gas, LPS, etc. In addition, the fuel cell system 100 may use oxygen gas stored in a separate location or air as an oxidizing agent that reacts with hydrogen.

The fuel cell system 100 includes a fuel cell stack 30 that generates power by using the fuel and the oxidizing agent, a fuel supply unit 10 that supplies the fuel to the fuel cell stack 30, and an oxidizing agent supply unit 20 that supplies an oxidizing agent for generating electricity to the fuel cell stack 30. The fuel supply unit 10 is connected with the fuel cell stack 30, and includes a fuel tank 12 that stores liquid fuel and a fuel pump 14 connected to the fuel tank 12. The fuel pump 14 pumps out liquid fuel stored in the fuel tank 12 with a predetermined pumping force. The fuel stored in the fuel supply unit 10 may be high-concentration methanol, but the invention is not limited thereto.

The oxidizing agent supply unit 20 is connected to the fuel cell stack 30, and includes an oxidizing agent pump 21 that suctions external air at a predetermined pumping force and supplies the external air to the fuel cell stack 30.

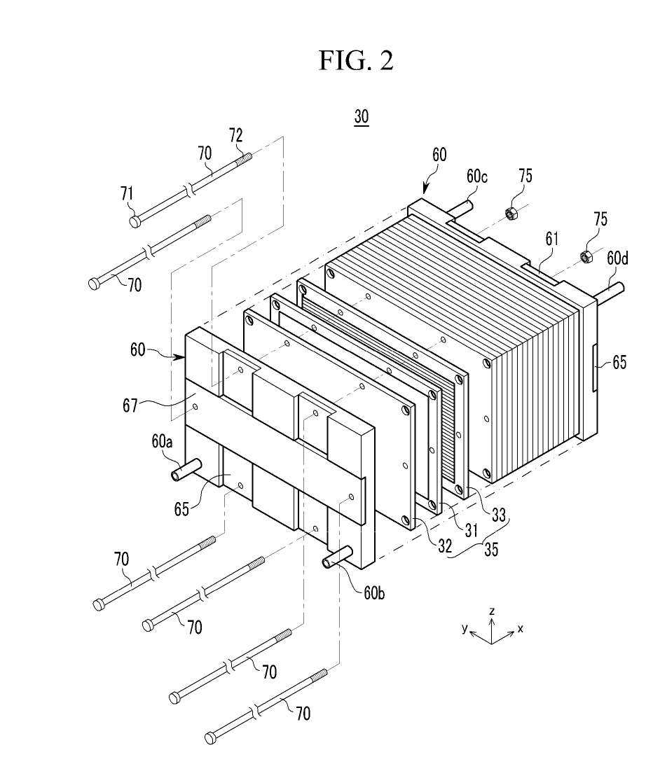

FIG. 2 is an exploded perspective view of a structure of the fuel cell stack 30 of FIG. 1. Referring to FIG. 1 and FIG. 2, the fuel cell stack 30 used in the fuel cell system 100 includes a plurality of electricity generators 35 that generate an oxidation/reduction reaction of fuel and an oxidizing agent to generate electrical energy.

Each of the electricity generators 35 is a unit cell that generates electricity. Each generator 35 includes a membrane-electrode assembly (MEA) 31 that oxidizes/reduces the fuel and oxygen included in the oxidizing agent, and separators 32 and 33 (also called bipolar plates in the art) for supplying the fuel and the oxidizing agent to the MEA 31. The electricity generator 35 has a structure in which the MEA 31 is arranged between separators 32 and 33. The MEA 31 includes an electrolyte membrane disposed in the center thereof, a cathode disposed in one side of the electrolyte membrane, and an anode disposed in the other side of the electrolyte membrane.

The MEA 31 is placed between the separators 32 and 33 which are closely positioned to each other, and respectively form a fuel path and an oxidizing agent path at both sides of the MEA 31. In this case, the fuel path is disposed on the anode of the MEA 31 and the oxidizing agent path is disposed on the cathode of the MEA 31. In addition, the electrolyte membrane enables ion exchange by moving protons generated in the anode to the cathode for combination with the oxygen to thereby generate water.

The fuel cell stack 30 of the fuel cell system 100 is formed by continuously arranging a plurality of electricity generators 35. Here, an end plate 60 is installed in the most external side of the fuel cell stack 30 to integrally fix the generator 35 to form the fuel cell stack 30.

In one side of the end plate 60, there are a fuel injection opening 60a for supplying the fuel to the fuel cell stack 30 and an oxidizing agent injection opening 60b for supplying the oxidizing agent to the stack 30. In the other end plate 60, there are a fuel emitting opening 60c for emitting unreacted fuel remaining after reaction in the anode and an oxidizing emitting opening 60d for emitting moisture generated from the combination reaction of the hydrogen and the oxygen in the cathode and unreacted air.

The end plates 60 are disposed facing each other. A fastening member 70 passes through the end plates 60. The fastening member 70 has the shape of a bolt. A head unit 71 having a horizontal cross-section that is larger than that of the fastening member 70 is formed in one end of the fastening member 70, and a screw thread 72 that is shaped to receive the threads of a nut 75 is formed in the other end.

When the fastening member 70 is inserted into the fuel cell stack 30, the head unit 71 supports the fastening member 70 from one side and the nut 75 combined to the screw thread 72 supports the fastening member 70 from the other side, thereby pressing inwardly and supporting the end plates 60. Accordingly, the electricity generators 35 can be closely adhered.

While not restricted thereto, the shown example has six fastening members 70 inserted into the end plates 60, and are simultaneously rotated by using a pressure device while the end plates 60 are fixed with a locking device (not shown) to thereby fix nuts 75 to the fastening members 70. When the fastening members 70 are simultaneously fixed, generation of pressure deviation between the fastening members 70 can be prevented so that uniform fastening pressure can be applied. However, it is understood that other numbers of fastening members can be used.

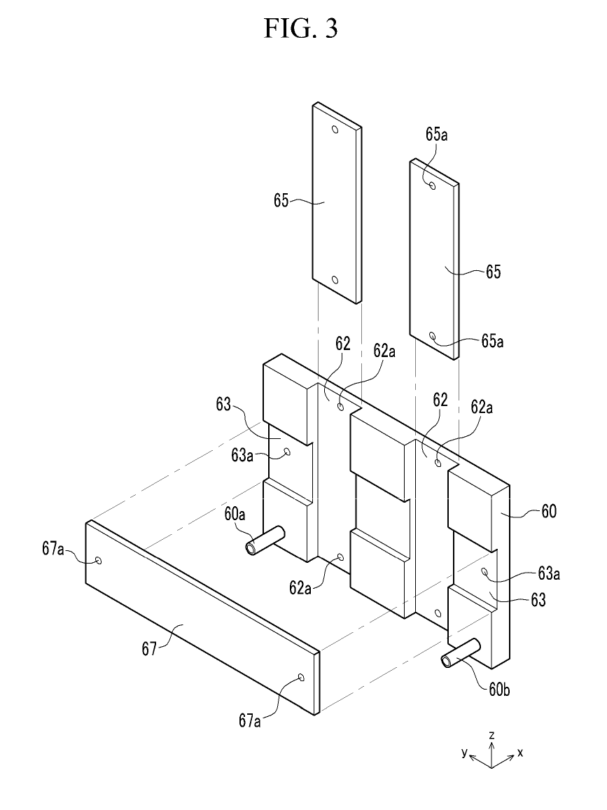

FIG. 3 is an exploded perspective view of the end plate 60 according to the first exemplary embodiment of the present invention. Referring to FIG. 3, in the end plate 60, a first groove 63 extending in a length direction (i.e., the y axis direction in FIG. 3) of the end plate 60 is formed, and a second groove 62 extending in a height direction that crosses the length direction is formed. Since the first groove 63 is formed in a center of the height direction of the end plate 60, the first groove 63 extends from one end of the length direction to the other end thereof.

The second groove 62 is formed at two locations of the end plate 60, and each groove 62 extends from one end of the height direction of the end plate 70 to the other end thereof. The second grooves 62 are deeper than the first groove 63, and the first groove 63 and the second grooves 62 perpendicularly cross each other.

A first reinforcing member 67 having a rectangular panel shape is inserted into the first groove 63. A second reinforcing member 65 having a rectangular panel shape is inserted in the second groove 62. The first reinforcing member 67 and the second reinforcing member 65 are made of a material having greater hardness than the end plate 60, and the material may be a chromium alloy or a nickel alloy. The end plate 60 is made of a material of which corrosion resistance is greater than the first and second reinforcing members 65 and 67, and the material may be stainless steel.

In addition, a hole 67a to which the fastening member 70 is inserted is formed in the first reinforcing member 67. A hole 65a to which the fastening member 70 is inserted is formed in the second reinforcing member 65. A hole 63a to which the fastening member 70 that penetrates the hole 67a of the first reinforcing member 67 is formed in the first groove 63, and a hole 62a to which the fastening member 70 that penetrates the hole 65a of the second reinforcing member 65 is formed in the second groove 62. Accordingly, the first reinforcing member 67 and the second reinforcing member 65 support the fastening member 70 by pressing the end plate 60.

The first reinforcing member 67 is provided further outside than the second reinforcing member 65 and is in contact with the second reinforcing member 65, and presses the second reinforcing member 65. Particularly, the first reinforcing member 67 presses a center portion of the second reinforcing member 65.

As described above, when the first reinforcing member 67 and the second reinforcing member 65 indirectly press the fuel cell stack 30 through the end plate 60, application of local pressure to the end plate 60 can be prevented since the entire end plate 60 can be pressed.

Accordingly, the end plate 60 can stably adhere the fuel cell stack 30 by applying uniform pressure thereto, and centralization of stress to inlets of the fuel path and the oxidizing agent path can be prevented.

Particularly, when the first reinforcing member 67 and the second reinforcing member 65 are made of a material of which strength is greater than the end plate 60, uniform pressure can be applied to the end plate 60 without deformation of the reinforcing members 67 and 65. In addition, since the first reinforcing member 67 and the second reinforcing member 65 are installed neighboring each other in the center of the end plate 60, the center of the end plate 60 can be stably applied with pressure. Further, since the center portion of the second reinforcing member 65 is pressed by the first reinforcing member 67, the second reinforcing member 65 can more easily press inside the end plate 60.

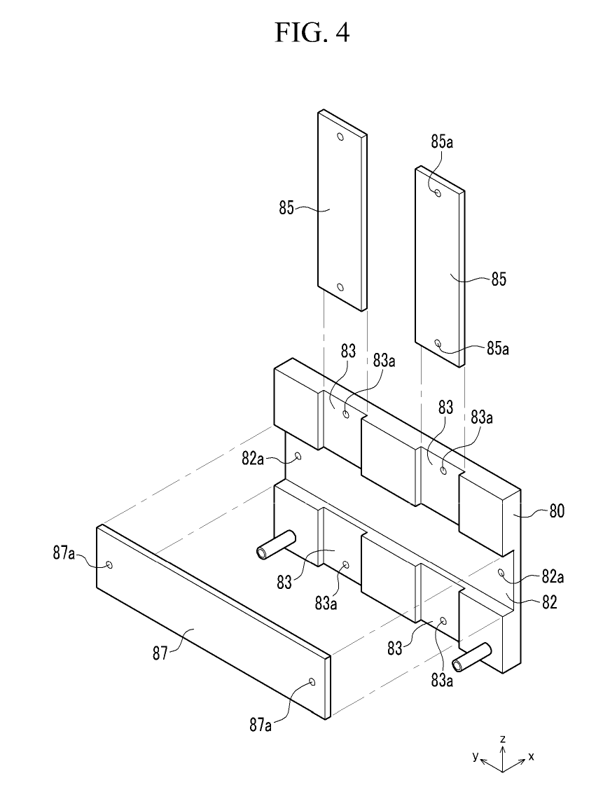

FIG. 4 is an exploded perspective view of an end plate according to a second exemplary embodiment of the present invention. Referring to FIG. 4, in an end plate 80 according to the present exemplary embodiment, a first groove 82 extending in a length direction (i.e., y axis direction in FIG. 4) of the end plate 80 is formed, and two second grooves 83 extending in a height direction (i.e., z axis direction in FIG. 4) of the end plate 80 crossing the length direction are formed.

The first groove 82 is parallel with a longer side of the end plate 80, and the second grooves 83 are parallel with a shorter side of the end plate 80. In addition, the first groove 82 is deeper than the second grooves 83, and the first groove 82 and the second grooves 83 perpendicularly cross each other. However, this aspect of the present invention is not limited thereto, and the first and second grooves 82 and 83 may extend in a diagonal direction of the end plate 80 and cross each other.

A first reinforcing member 87 is inserted into the first groove 82 and second reinforcing members 85 are inserted into the second grooves 83, and accordingly, a portion of the second reinforcing members 85 are covered by the first reinforcing member 87.

In addition, a hole 87a to which a fastening member is inserted is formed in the first reinforcing member 87, and a hole 85a to which the fastening member is inserted is formed in the second reinforcing member 85. Further, a hole 83a to which the fastening member that penetrates the hole 87a of the first reinforcing member 87 is formed in the first groove 83, and a hole 82a to which the fastening member that penetrates the hole 85a of the second reinforcing member 85 is formed in the second groove 82.

Accordingly, when the fastening member 70 is installed, the first reinforcing member 87 presses the second reinforcing member 85 so that appropriate pressure can be applied to a center portion of a fuel cell stack while preventing torsion of the first reinforcing member 87. According to the present exemplary embodiment, since the second reinforcing members 85 support the first reinforcing member 87 that is relatively longer than the second reinforcing members 85 with pressure, deformation of the first reinforcing member 87 can be prevented even though fastening force is applied for a long period of time.

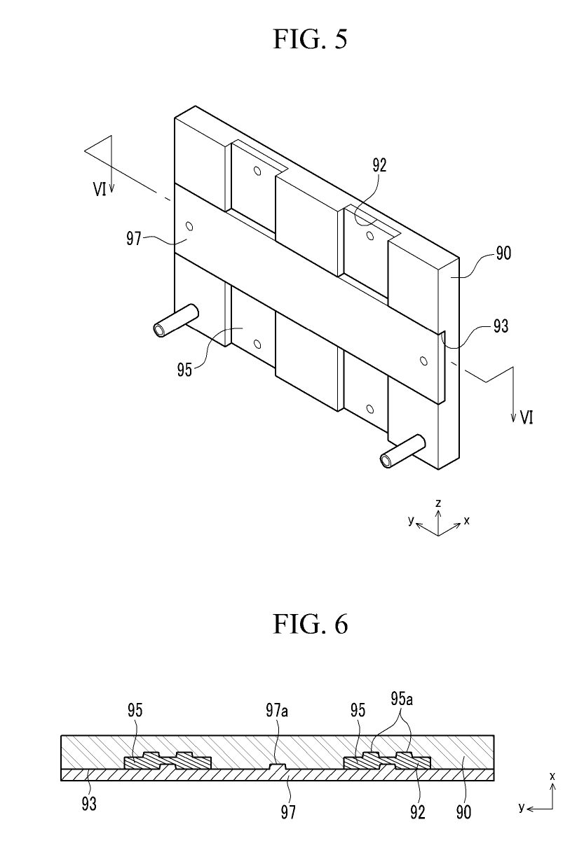

FIG. 5 is an exploded perspective view of an end plate according to a third exemplary embodiment of the present invention, and FIG. 6 is a cross-sectional view of FIG. 5, taken along the line VI to VI. Referring to FIG. 5 and FIG. 6, in an end plate 90 a first groove 93 extended in a length direction (i.e., y axis direction in FIG. 5) of the end plate 90 is formed, and two second grooves 92 extended in a height direction (i.e., z axis direction in FIG. 5) of the end plate 90, crossing the length direction of the end plate 90, are formed.

A first reinforcing member 97 is inserted into the first groove 93 and a second reinforcing member 95 is inserted the second groove 92, and accordingly, the first reinforcing member 97 is located further to an outside surface than the second reinforcing member 95. The first reinforcing member 97 and the second reinforcing member 95 are respectively disposed in directions that are perpendicular to each other.

A pressure protrusion 95a is formed in the second reinforcing member 95, and the pressure protrusion 95a is formed to press inside, particularly, at a center portion of the end plate 90. In addition, a pressure protrusion 97a is formed in the first reinforcing member 97, and the pressure protrusion 97a is formed in an area where the center portion of the end plate 90 and the second reinforcing member 95 contact each other.

Accordingly, the first reinforcing member 97 can more stably press the second reinforcing member 95, and an inside portion of the end plate 90, separated from the fastening member, can be easily pressed.

The size and number of pressure protrusions are not limited, and a plurality of fine pressure protrusions may be formed to press the center portion of the end plate.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell stack comprising:
a plurality of electricity generators, each generator generating electricity by a reaction of a fuel and an oxidizing agent; and
end plates disposed at outermost parts of the plurality of electricity generators,
wherein in each end plate there is a first groove extended in one direction and a first reinforcing member that supports the end plate is placed on the first groove.

2. The fuel cell stack of claim 1, wherein each of the electricity generators includes a membrane electrode assembly (MEA) and separators disposed at respective sides of the MEA.

3. The fuel cell stack of claim 1, wherein the end plate are installed in the outermost parts of the electricity generators, the first reinforcing member is placed over each of the end plates, and a fastening member that presses the first reinforcing member is installed in the first reinforcing member.

4. The fuel cell stack of claim 3, wherein the fastening member comprises a bolt that traverses the first reinforcing member and a nut which is inserted at an end of the bolt.

5. The fuel cell stack of claim 1, further comprising a fastening member comprising a bolt that traverses the first reinforcing member and a nut which is inserted at an end of the bolt and which extends between and fastens the end plates to press together the electricity generators.

6. The fuel cell stack of claim 1, wherein the first reinforcing member supports a center of the end plate.

7. The fuel cell stack of claim 1, wherein the first groove is extended from one end of the end plate to the other end of the end plate.

8. The fuel cell stack of claim 1, wherein the first reinforcing member is made of a material of greater strength than the end plate.

9. The fuel cell stack of claim 1, wherein the end plate is made of a material of greater corrosion resistance than the first reinforcing member.

10. The fuel cell stack of claim 1, wherein each of the end plates further includes a second groove that crosses the first groove, and a second reinforcing member that presses the end plate is formed in the second groove.

11. The fuel cell stack of claim 10, wherein the second groove perpendicularly crosses the first groove.

12. The fuel cell of claim 10, wherein the first or second groove includes a plurality of grooves.

13. The fuel cell stack of claim 10, wherein the first reinforcing member is placed below the second reinforcing member so that the second reinforcing member supports the first reinforcing member.

14. The fuel cell stack of claim 10, wherein the second reinforcing member is placed below the first reinforcing member so that the first reinforcing member presses the second reinforcing member into the second groove.

15. The fuel cell stack of claim 10, wherein the second reinforcing member further includes a pressure protrusion.

16. The fuel cell stack of claim 10, further comprises a pressing protrusion on at least one of the first reinforcing member and the second reinforcing member in an area where the first and second reinforcing members are in contact with each other.

17. A fuel cell system comprising:
a fuel cell stack to generate electricity by a reaction of a fuel and an oxidizing agent:
a fuel supply source to supply a fuel to the fuel cell stack; and
an oxidizing agent supply source to supply an oxidizing agent to the fuel cell stack,
wherein the fuel cell stack comprises:
an electricity generator including a membrane electrode assembly (MEA) and separators disposed at respective sides of the MEA and end plates disposed at outermost parts of the electricity generator, and
wherein in each end plate there is a first groove extended in one direction and a first reinforcing member that supports the end plate and is placed on the first groove.

18. The fuel cell system of claim 17, wherein each of the end plates further includes a second groove that crosses the first groove, and a second reinforcing member that presses the end plate into the second groove.

19. The fuel cell system of claim 18, wherein the second reinforcing member further includes a pressure protrusion.

20. The fuel cell system of claim 18, further comprises a pressing protrusion on at least one of the first reinforcing member and the second reinforcing member in an area where the first and second reinforcing members are in contact with each other.
